(19) United States
(12) Patent Application Publication
(10) Pub. No.: US 2002/0005626 A1
(43) Pub. Date: Jan. 17, 2002

(54) Elevating plate and glide board with an elevating plate

(76) Inventors: Christian Haas, Bogen (DE); Tobias Heil, Mitterfels (DE)

Correspondence Address: HOFFMAN, WASSON & GITLER, PC, Suite 522, 2361 Jefferson Davis Highway, Arlington, VA, 22202, US

(21) Appl. No.: 09/873,407

(22) Filed: Jun. 5, 2001

(30) Foreign Application Priority Data
Jun. 9, 2000 (DE) 100 28 211.3
Jul. 26, 2000 (DE) 100 36 236.2

(51) Int. Cl. A63C 9/08; B62M 27/00

(52) U.S. Cl. 280/613; 280/14.21

(57) ABSTRACT

The invention pertains to a new type of elevating plate for the binding or a binding element of a glide board, especially of a snowboard.

The invention pertains to a plate or elevating plate for the binding or a binding element of a slide or glide board, a snow glide board or snowboard, for example, consisting of at least two plate elements, which form an opening in between for the fastening or fixing means holding the binding and interlocking with the glide board and which are adjustable in relation to each other for setting the effective width of the plate perpendicular to a middle plane intersecting a plate top and a plate bottom. Furthermore, the invention also pertains to a slide or glide board, a snow glide board or snowboard, for example with such an elevating plate.

Especially for snowboards it is becomingly increasingly common to use plates that are located between the top of the snowboard and the respective binding element and that serve to elevate the mounting plane for the respective binding element and therefore to increase the standing height in order to improve the handling properties of the board.

It is also common practice to manufacture such elevating plates for snowboards in several parts, consisting of two outer, semi-ring-shaped plate elements made of plastic and a middle circular disk-shaped plate element that is also made of plastic and in assembled condition extends beyond the two outer plate elements on an inner edge, so that the outer plate elements in assembled condition are clamped tightly between the inner plate element and the top of the snowboard. The respective binding element is then supported by bearing surfaces on the outer plate elements, however only in a relatively limited angle area, by means of which the binding element is adjustable in relation to the plate on an axis that is perpendicular to the top or bottom of the plate. The multi-element design of the plate enables, for example, adjustment of the width to different snowboard widths.

The disadvantages of the plate according to the state of the art include,

that it consists of numerous single elements, which makes assembly difficult,

that the angle adjustment area of the binding element in relation to the length of the snowboard is limited, and

that the transfer of force from the binding across the plate to the snowboard and especially to the area of the longitudinal edges is not ideal.

One object of this invention is to present an elevating plate that prevents the disadvantages of the prior art and provides improved transfer of force from the binding or the respective binding element to the glide board (especially snowboard). To achieve this object, an elevating plate for the binding or a binding element of a glide board, a snow glide board or snowboard, for example, consisting of at least two plate elements, which form an opening in between for the fastening or fixing means holding the binding and interlocking with the glide board and which are adjustable in relation to each other for setting the effective width of the plate perpendicular to a middle plane intersecting a plate top and a plate bottom

is characterized in that the plate elements are connected while being adjustable in relation to each other and

that on one side of the plate the plate elements form at least one arm or wing standing away from the plate for bearing against the glide board.

A glide board, a snow glide board or snowboard, for example, with an elevating plate for the binding or a binding element of said glide board, said elevating plate consisting of at least two plate elements, which form an opening in between for the fastening or fixing means holding the binding and interlocking with the glide board and which are adjustable in relation to each other for setting the effective width of the plate perpendicular to a middle plane intersecting a plate top and a plate bottom,

is characterized in that the plate elements are connected while being adjustable in relation to each other and

that on at least one side of the plate the plate elements form at least one arm or wing standing away from the plate for bearing against the glide board near a longitudinal side of the glide board.

The plate according to the invention has the following advantages over the prior art. The plate according to the invention provides a more direct transfer of force from the binding to the respective glide board (e.g. snowboard), especially in the direct vicinity of the longitudinal sides of the snowboard.

In one embodiment according to the invention, the plate elements are connected to each other while still being moveable in relation to each other, so as to avoid several loose plate elements that are first connected to each other during assembly, which simplifies the assembly process.

Furthermore, the embodiment according to the invention provides an optimum and symmetrical transfer of force from the binding to the snowboard.

Preferably the plate is designed on the side adjacent to the arms or wings with at least one pointed end. This design prevents such continuous edges, i.e. straight or essentially straight edges extending along the entire width of the snowboard, which could cause breakage of the snowboard. Furthermore, this design also avoids or essentially prevents negative effects on the bending line of the glide board.

In a preferred embodiment the plate has elastic areas especially on the ends of the arms or wings and at least on the bottom of the plate, which also provides an optimum, even transfer of force from the plate to the glide board and prevents negative effects on the bending line of the glide board. For example, liners or inserts made of an elastomeric material are provided for on the bottom of the plate, whereby these inserts also have a damping effect. The elastomeric inserts can have different hardnesses (Shore hardnesses), classified according to different weight classes depending on the individual user.

Further embodiments of the invention are the subject of the dependent claims. The invention is described in more detail below by way of examples and based on the figures which show embodiments of the invention:

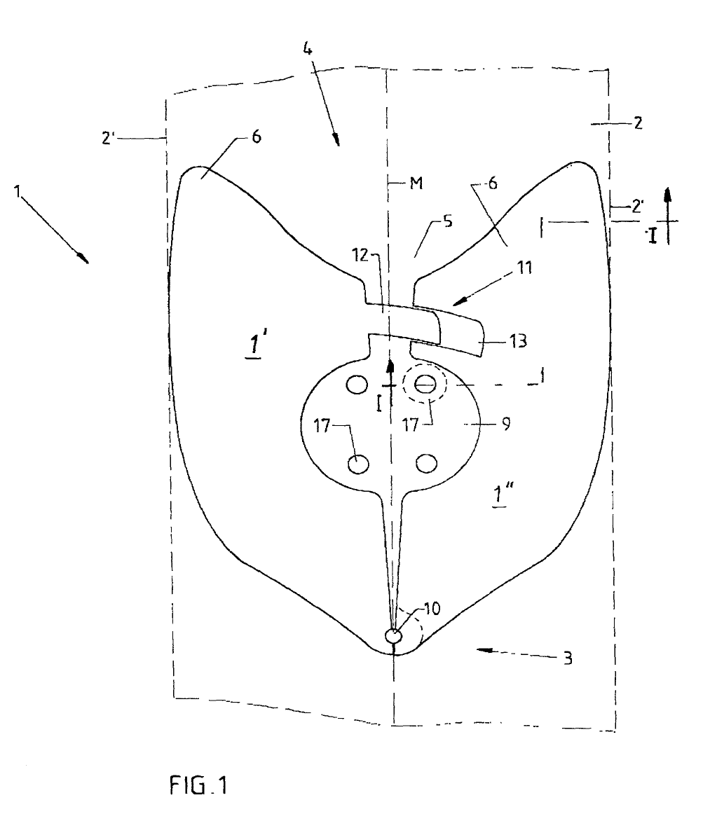

FIG. 1—a simplified depiction in top view of a plate of a plate system for use in glide boards for snow, especially snowboards;

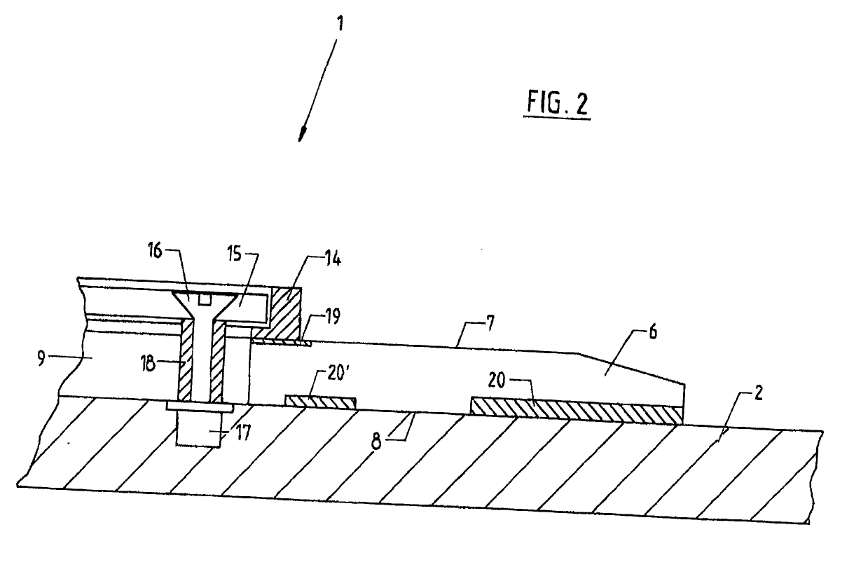

FIG. 2—a simplified representation in cross-section corresponding to the line I-I of FIG. 1;

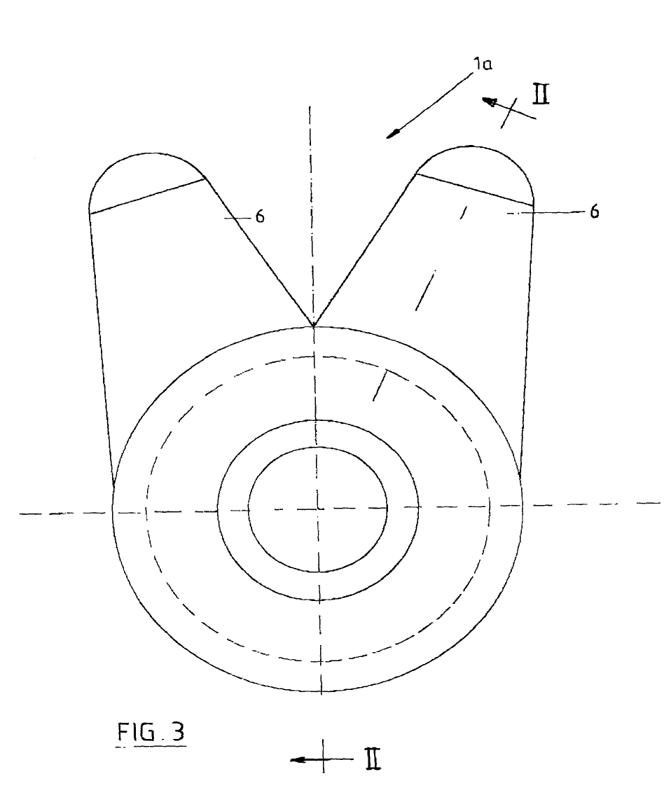

FIG. 3—a simplified representation in top view of a further possible embodiment of the plate according to the invention;

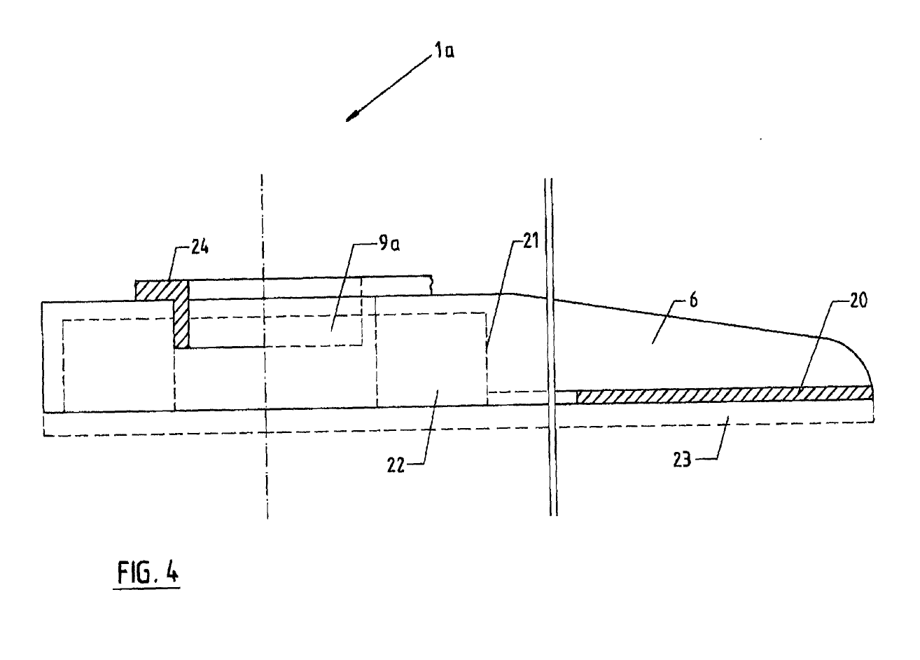

FIG. 4—a cross-section corresponding to the line II-II of FIG. 3;

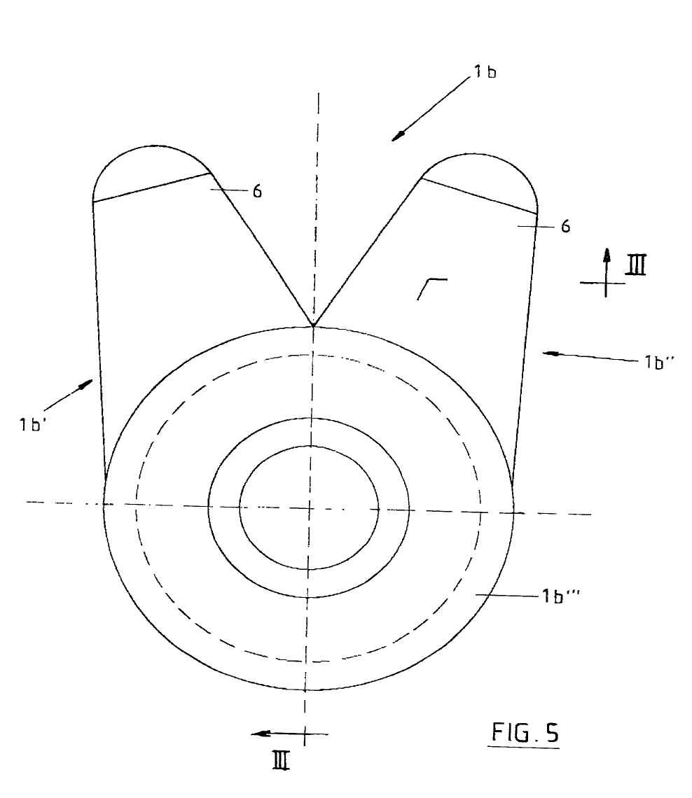

FIG. 5—a simplified representation in top view of a further possible embodiment of the plate according to the invention;

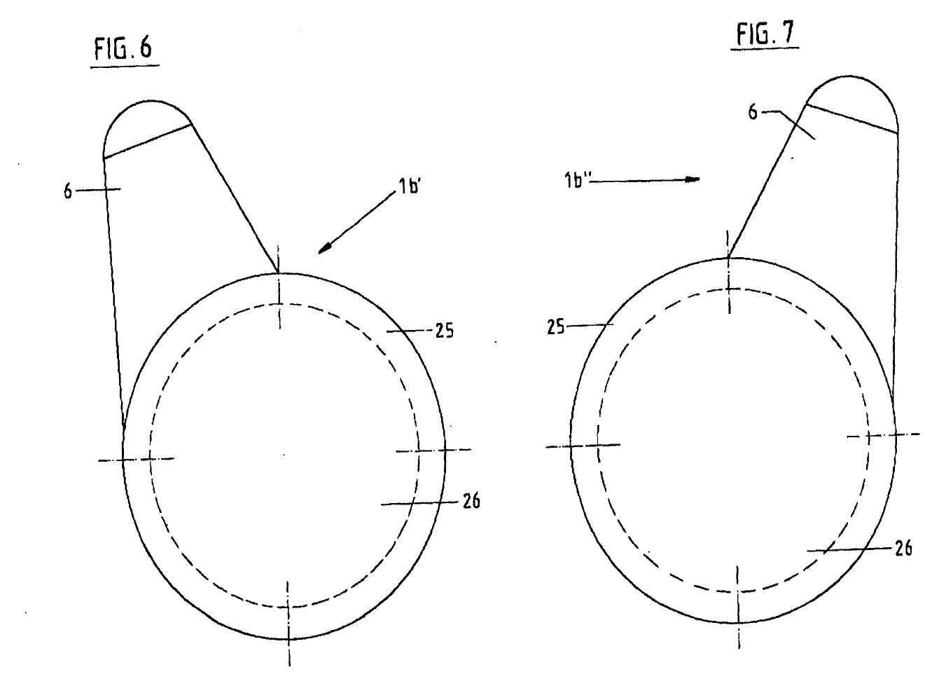

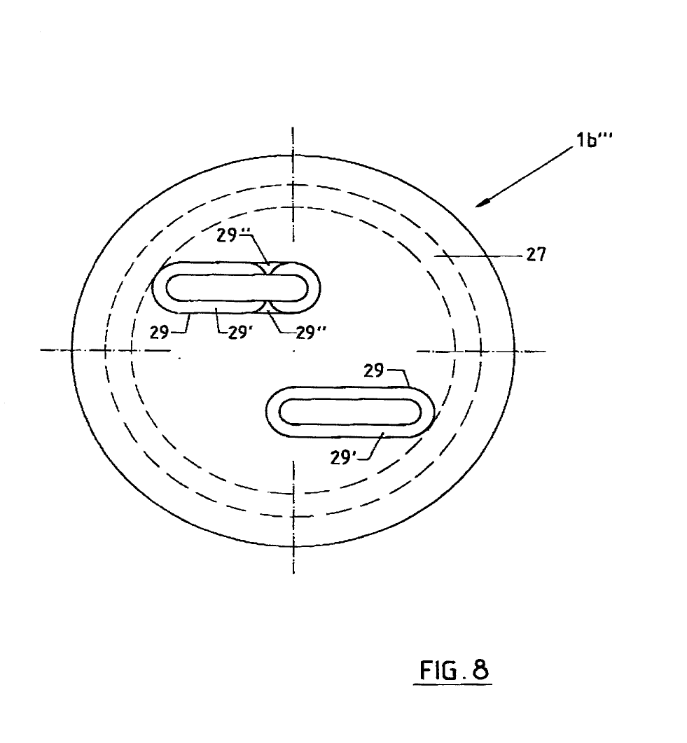

FIG. 6 and 7—simplified representations in top view of one of the two plate elements with the wings or arms;

FIG. 8—a simplified representation in top view of the upper plate element of the elevating plate in FIG. 5;

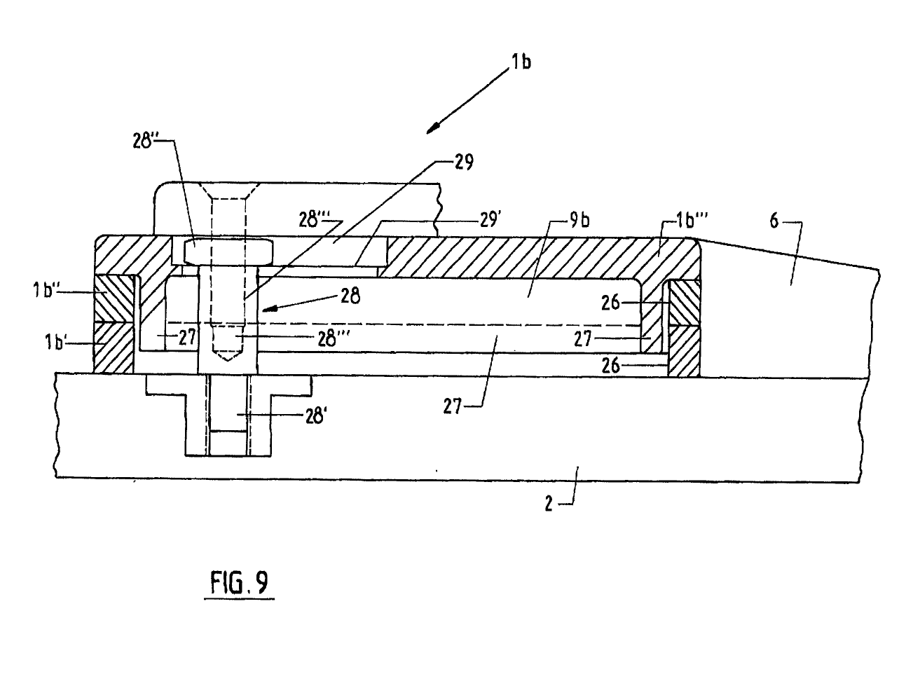

FIG. 9—a cross-section corresponding to the line III-III of FIG. 5.

The plate (elevating plate) generally designated 1 in FIGS. 1 and 2 is part of a plate system that includes two such plates that both are mounted in the area of one of the two binding elements of the binding on the top of a snowboard 2 indicated only schematically in FIG. 1.

The plate 1 has an essentially heart-shaped form in top view, i.e. tapering on one end, i.e. in the depiction in FIG. 1 on the lower end 3, and on the top end 4 has two pointed arms or wings 6 that form a notch 5 between them.

The plate 1 is divided along a middle plane M, i.e. it consists of the two plate elements 1′ and 1″. The middle plane M extends between the two ends 3 and 4. In relation to this middle plane M, which also lies perpendicular to the plane of the top 7 and bottom 8 of the plate 1 or plate elements 1′ and 1″, the plate 1 has a symmetric external shape at least in top view. In the middle of the plate 1 the two plate elements are provided with a partially circular recess on the side adjacent to the middle plane M in the depicted embodiment, which (recesses) combine to form a common middle opening 9.

In the area of the end 3 the two plate elements 1′ and 1″ are connected with each other in a pivoting manner by means of a joint 10, the joint axis of which lies in the middle plane M and perpendicular to the planes of the top 7 and bottom 8, in such a manner that the width of the plate 1 in the area of the end 4, i.e. the distance of the two wings 6 from each other there in the axis direction perpendicular to the middle plane M, can be changed or optimally adapted to the width of the snowboard 2, so that the respective plate 1 with the wings 6 is as close as possible to the respective longitudinal side 2 of the snowboard 2. Between the end 4 or the notch 5 there and the opening 9, the two plate elements 1′ and 1″ interlock in such a way that pivoting of the plate elements 1′ and 1″ around the joint 10 is possible, while there is at least a certain tight connection between the plate elements 1′ and 1″ also between the opening 9 and the end 4.

In the depicted embodiment, this guide between the plate elements 1′ and 1″ is designed in such a way that the plate element 1″ is provided with a partially circular projection 12 on its side adjacent to the middle plane M, which (projection) interlocks with an adapted guide opening 13 that is provided for on the side of the plate element 1′ adjacent to the middle plane M.

The plate 1 is mounted on the top of the snowboard 2 in such a way that the middle plane M is parallel or essentially parallel to the longitudinal extension of the snowboard 2 and the wings extend away from the middle of the snowboard 2, i.e. both face an end of the snowboard 2. The width of the plate 1 is adjusted by means of the joint 10 in such a way that each wing 6 extends as close as possible to a longitudinal side 2′.

The binding (binding element) 14, of which FIG. 2 for the sake of clarity depicts only one plate and one circular holding or binding plate 15, is mounted in the area of the opening 9. The binding 14 in the depicted embodiment bears with its bottom against the top 7 of the plate 1 and is pressed or braced against the top 7 of the plate 1 by means of the binding plate 15 and fastening screws 16. The fastening screws 16, which penetrate openings in the binding plate 15 and the heads of which bear against the binding plate 15, are inserted into threaded elements or inserts 17 that are pre-mounted in a predetermined grid in the snowboard 2. In order to prevent the inserts 17 from being pulled out of the snowboard when tightening the fastening screw 16 and tensioning of the binding plate 14 between the plate 1 and the holding plate 15, the fastening screws 16 are encased by a distance sleeve 18, the top end of which bears against the holding plate 15 and the bottom of which bears against the snowboard 2 in the area of an insert 17. All fastening screws 16 and the corresponding distance sleeves 18 are accommodated in the opening 9. When a fastening screw 16 is in a loosened state, adjustment of the binding 14 is possible for achieving a variety of angle positions relative to the cross axis of the snowboard, for example an angle range of +/−35°.

By means of the fastening screws 16 the plate 1 is anchored only in its middle area to the snowboard 2, which helps considerably in reducing a negative effect of the respective plate 1 on the flexibility or bending line (flex gradient) of the snowboard 2.

To prevent unwanted twisting of the binding 14 after making an adjustment and after tightening the fastening screws 16, an intermediate layer 19 made of a material with increased friction coefficients, for example an elastomeric material, is preferably located between the bottom of the binding 14 and the top 7 or the plate 1 and is manufactured with a suitable surface or surface coating.

As shown in FIG. 2, the plate 1 at the end of the wings 6 is designed in such a way that it forms an elastic or damping bearing surface against the top of the snowboard 2. In the depicted embodiment this is achieved by inserts 20 made of an elastic or damping material on the bottom of the plate 1 in the area of the wings 6; however, it is also generally possible to manufacture the wings 6, at least in the area of their ends, of an elastic and/or damping material.

The plate 1 or its plate elements 1′ or 1″ can, for example, be injection moulded parts made of plastic, where especially this construction makes it possible for the plate elements 1′ and 1″ to be very stiff and rigid in the area of the end 3, in the middle of the plate 1 in the area of the opening 9 there and for then to become increasingly elastic at the ends of the wings 6.

The above-described outer shape of the plate 1 (tapering end 3 and end 4 with the wings 6 forming the recess 5), with the possibility of adapting the width of the plate 1 to the snowboard width and with optimum transfer of force from the binding 14 to the snowboard 2, especially by means of the wings 6 all the way to the respective longitudinal side 2′, prevents continuous plate edges extending crosswise to the snowboard 2 that could cause breakage of the snowboard 2 during use.

In addition to the inserts 20, additional inserts 20′ made of an elastomeric material are distributed on the bottom 8 of the plate, in order to provide a non-slip connection to the plate bottom 8 and the top of the snowboard 2. Instead of additional inserts 20′ the plate bottom 8 can also be at least partially provided with a coating made of a material capable of preventing the plate from slipping.

FIGS. 3 and 4 depict as a further possible embodiment a plate 1a, which in top view likewise is symmetrical to the middle plane M at least with respect to its outer shape and for width adjustment consists of the two plate elements 1a′ and 1a″ connected to each other by means of a joint, each (plate element) forming a wing 6. The plate 1a differs from the plate 1 essentially in that the plate elements 1a′ and 1a″ in the area of the circular opening 9a corresponding to the opening 9 are connected to each other by means of a joint on the axis of this opening 9a extending perpendicular to the plate top 7 and plate bottom 8, in the manner that one of the two plate elements, for example the plate element 1a′, has an enlargement 21 that is open toward the bottom 8 in the area of the opening 9a, into which (enlargement) a corresponding peg-like projection 22 of the other plate is inserted. Other possibilities for the joint connection of the plate elements 1a′ and 1a″ are also conceivable.

As indicated in FIG. 4, height adjustment of the plate 1a is possible by providing additional inserts 23 on the bottom 8 of the plate, which are made of the elastomeric material, for example in the area of the arms or wings 6. Furthermore, it is possible to provide for inserts 24 of different heights on the top 7 of the plate for the purpose of height adjustment.

FIG. 5 shows in a depiction similar to FIG. 3 as a further possible embodiment of the invention an elevating plate 1b with a three-part design comprising the plate elements 1b′, 1b″ and 1b′″. The plate elements 1b′ and 1b″ each consist of an essentially ring-shaped plate section 25 with a ring opening 26 and each with a wing 6 extending approximately radially from the plate section 25. With the elevating plate 1b mounted, the two ring openings 26 form the opening 9b corresponding to the opening 9a. The plate elements 1b′ and 1b″ are furthermore designed in such a way that, with congruent ring openings 26 arranged one above the other, they lie at least with the bottom of their wings 6 in a common plane or with the plate 1b mounted on the snowboard 2 with the bottom of their wings 6 on the top of the snowboard, as depicted in FIG. 9.

With the elevating plate 1b mounted, the plate element 1b′″ is located above the plate elements on the side of the elevating plate facing away from the snowboard 2, which (plate element 1b′″) in the depicted embodiment has a cylindrical shape and closes the opening 9b on the top of the elevating plate 1b. The binding is then mounted on the plate element 1b′″.

The plate elements 1b′, 1b″, 1b′″ are joined together in such a way that pivoting of the arms 6 on the middle axis of the opening 9b is possible. In the depicted embodiment, a ring-shaped flange 27 is molded on for this purpose on the bottom of the plate element 1b′″, which (flange) is inserted into the congruent openings 26 of the plate elements 1b′ and 1b″. Another method for interlocking of the plate elements 1b′-1b′″ is also possible. Furthermore, the plate elements 1b′-1b′″ are provided with adjacent surfaces with catches or teeth so that after fastening of the elevating plate 1b to the snowboard 2, the position of the plate elements 1b′-1b′″ in relation to each other is also secured by the interlocking catches or teeth.

The elevating plate 1b is mounted on the snowboard using stud bolts 28 that are provided with a threaded section 28′ on the lower end of the bolt, which can be used to anchor the stud bolts 28 to the snowboard 2 by screwing, e.g. in inserts 17 located there. On the top end the stud bolts 28 are provided with a radially extending flange or collar 28″, with which the stud bolts 28 bear against the upper plate element 1b′″, in the area of fastening holes 29 located there. On the top end the stud bolts 28 are provided with inner threads 28′″, into which screws can be inserted for fastening the binding, i.e. of the respective binding element.

The fastening holes 29 are designed as oblong holes, with a depressed edge section 29′ on the top of the plate element 1b′″, which (edge section) serves to accommodate the collar 28″, so that the top of each stud bolt 28 is even with the top of the plate element 1b′″, forming a bearing surface for the binding. The oblong shape of the fastening holes 29 enables infinite adjustment of the elevating plate 1b in the longitudinal direction of the fastening holes 29, i.e. preferably in the longitudinal direction of the snowboard.

The plate element 1b′″ is provided with a number of such fastening holes 29, at least crosswise to the longitudinal extension of these openings at a mutual distance or in a grid in such a way that fastening of the plate 1b at least on snowboards with all common grids for the arrangement of the inserts 17 is possible. Also such grids that are not common can be considered for use due to the oblong shape of the openings 29 and by turning or slanting the plate element 1b′″ in relation to the longitudinal or lateral axis of the snowboard 2.

It is also possible to design the depressed edge area 29′ not as a continuous area, but rather in sections, as indicated in FIG. 8 by the interruptions 29″. Each section is then suitable for accommodation of the collar 28″. With the multi-element design of the edge areas 29′, after mounting or tightening of the stud bolts 28 the elevating plate 1b is secured firmly against unwanted slipping on the top of the snowboard.

The above-described use of stud bolts 28 for fastening has the advantage that these stud bolts serve as distance elements and enable loosening of the binding, for example for adjustment in relation to the elevating plate 1b, without loosening or removing the elevating plate 1b.

The above-described plates 1-1b have the following advantages in particular:

The negative effect on the bending line (flex gradient) of the snowboard 2 is reduced to a minimum.

The plates 1-1b ensure the elevation of the respective binding 14 and therefore a standard elevation.

The linking of plate elements by a joint enables the width adjustment of the plate 1-1b and therefore the adjustment to snowboards of varying widths.

The respective plate 1-1b is adjustable in the longitudinal direction of the snowboard with the corresponding binding 14, in steps according to the grid in which the inserts 17 are located in the longitudinal direction of the snowboard, but also continuously by the fact that the respective opening 9, 9a or 9b has a diameter that is larger than the grid spacing of the insert 17.

Moreover, an angle compensation or angle adjustment for the binding 14 is possible.

The respective binding can be mounted in the common angle positions.

The plates 1-1b are suitable for all common binding systems.

The plate elements are connected to each other; the plate itself therefore has no loose parts that make assembly difficult.

A flexible transition from the middle fastening area of the binding and the front ends of the two arms or wings is ensured.

The plate 1-1b is secured against slipping on the top of the snowboard by means of the inserts 20 and the additional elastomeric inserts or layers 20′.

Height adjustment is possible by means of inserts with differing heights or by means of additional inserts.

The invention was described above based on sample embodiments. Of course, numerous adaptations and modifications are possible without abandoning the underlying inventive idea. For example, instead of the distance sleeves 18, other distance means or elements could be used.

List of reference mumbers

1, 1a, 1b plate 18 distance sleeve

1′, 1″ plate element 19 intermediate elastomeric layer

1a′, 1a″ plate element 20, 20′ elastomeric insert

1b′, 1b″, 1b′″ plate element 21 recess

2 snowboard 22 joint projection

2′ long side of snowboard 23 liner

3, 4 end 5 notch 24 insert

6 wing or arm 25 plate section

7 top of plate 26 plate element opening

8 bottom of plate 27 ring flange

9, 9a, 9b opening 28 stud bolt

10 joint 28′ threaded section

11 guide 28″ collar

12 guide projection 28′″ inner thread

13 guide opening 29 mounting hole or oblong hole

14 binding 29′ recessed edge area

15 holding or binding plate 29″ interrupted edge area

16 fastening screw M middle plane

17 insert

1. Elevating plate for the binding or a binding element (14) of a glide board, a snow glide board or snowboard, for example, consisting of at least two plate elements (1′, 1″; 1a′, 1a″; 1b′, 1b″, 1b′″), which form an opening (9, 9a) in between for the fastening or fixing means (15, 16) holding the binding (14) and interlocking with the glide board (2) and which are adjustable in relation to each other for setting the effective width of the plate (1, 1a, 1b) perpendicular to a middle plane (M) intersecting a plate top (7) and a plate bottom (8),
characterized in that the plate elements (1′, 1″; 1a′, 1a″; 1b′, 1b″, 1b′″) are connected while being adjustable in relation to each other and
that on one side (4) of the plate (1, 1a, 1b) the plate elements (1′, 1″; 1a′, 1a″; 1b′, 1b″, 1b′″) form at least one arm or wing (6) standing away from the plate (1, 1a, 1b) for bearing against the glide board (2).

2. Plate according to claim 1, characterized in that it consists of at least two plate elements (1′, 1″) each forming an arm or wing (6).

3. Plate according to claim 1, characterized in that it consists of at least three plate elements (1b′, 1b″, 1b′″), of which two plate elements (1b′, 1b″) form the arms or wings (6) and of which a further plate element (1b′″) forms the top of the elevating plate.

4. Plate according to one of the foregoing claims, characterized in that the plate elements are held together in an interlocking manner.

5. Plate according to one of the foregoing claims, characterized in that the plate elements (1′, 1′″; 1a′, 1a″; 1b′, 1b″, 1b′″) are connected together in a pivoted manner by means of at least one joint (10) on an axis perpendicular to the top (7) or bottom (8) of the plate.

6. Plate according to one of the foregoing claims, characterized in that the respective arm or wing (6) extends radially or approximately radially from the plate in relation to the axis of the joint (10).

7. Plate according to one of the foregoing claims, characterized in that the pivot axis is formed by a joint (10) on a side (3) of the plate (1) opposite from the arms or wings (6).

8. Plate according to one of the foregoing claims, characterized in that the joint axis is located in the area of the opening (9a) of the plate (1a).

9. Plate according to one of the foregoing claims, characterized in that the arms or wings (6) stand away from a middle part of the plate (1, 1a, 1b) forming the opening (9, 9a).

10. Plate according to one of the foregoing claims, characterized in that the top (7) of the plate forms a surface for the binding or the binding element (14) in an area surrounding the opening (9, 9a).

11. Plate according to claim 10, characterized in that the surface for the binding element (14) is formed in such a way that the binding element is secured against twisting in relation to the plate (1, 1a, 1b).

12. Plate according to one of the foregoing claims, characterized in that the surface for the binding element (14) at least on the surface side adjacent to the binding element (14) is made of an elastomeric material.

13. Plate according to one of the foregoing claims, characterized in that it has an elastic form at least in the area of the arms or wings (6) at least on the bottom (8) of the plate.

14. Plate according to one of the foregoing claims, characterized in that inserts (20, 20′) or at least an intermediate layer (23) made of an elastomeric and/or damping material is provided for on the bottom (8) of the plate.

15. Plate according to one of the foregoing claims, characterized in that the fastening means (15, 16) are designed in such a way that an angle adjustment of the binding element (14) in relation to the plate (1) is possible.

16. Plate according to one of the foregoing claims, characterized in that it is essentially symmetrical in relation to the middle plane (M).

17. Plate according to one of the foregoing claims, characterized in that the fastening means (16) extending through the at least one opening (9, 9a) and interlocking with the glide board (2) and/or anchoring elements (17) located there also serves to fasten the plate (1) to the glide board (2).

18. Plate according to one of the foregoing claims, characterized in that the arms or wings (6) are tapered toward their free ends.

19. Plate according to one of the foregoing claims, characterized in that the plate height at least in the area of the arms or wings (6) becomes smaller toward its free end 20.

20. Plate according to one of the foregoing claims, characterized in that it is tapered on the side (3) adjacent to the arms or wings (6).

21. Plate according to one of the foregoing claims, characterized by liners (23) and/or inserts (24) for adjusting the height 22.

22. Plate according to one of the foregoing claims, characterized by its being manufactured from metal and/or plastic.

23. Plate according to one of the foregoing claims, characterized in that the fastening means for fastening the plate to the glide board consist of bolts (28) that can be anchored with one end in the glide board or in anchoring elements (17) located there and have means, for example a thread or a threaded hole (28′″) for fastening a binding or a binding element.

24. Plate according to claim 23, characterized in that the bolts (28) form a bearing surface (28″) for bearing against the plate or a plate element (1b″).

25. Plate according to claim 23 or 24, characterized in that the bolts (28) form a bearing surface (28″) for the binding.

26. Plate according to one of the foregoing claims, characterized in that the bolts are provided with a collar (28″) for bearing against the plate or against a plate element (1b′″).

27. A glide board, a snow glide board or snowboard, for example, with an elevating plate for the binding or a binding element (14) of said glide board, said elevating plate consisting of at least two plate elements (1′, 1″; 1a′, 1a″; 1b′, 1b″, 1b′″), which form an opening (9, 9a) in between for the fastening or fixing means (15, 16) holding the binding (14) and interlocking with the glide board (2) and which are adjustable in relation to each other for setting the effective width of the plate (1, 1a, 1b) perpendicular to a middle plane (M) intersecting a plate top (7) and a plate bottom (8),
characterized in that the plate elements (1′, 1″; 1a′, 1a″; 1b′, 1b″, 1b′″) are connected while being adjustable in relation to each other and that on at least one side (4) of the plate (1, 1a, 1b) the plate elements (1′, 1″; 1a′, 1a″; 1b′, 1b″, 1b′″) form at least one arm or wing (6) standing away from the plate (1, 1a, 1b) for bearing against the glide board (2) near a longitudinal side of the glide board (2).

28. Glide board according to claim 27, characterized in that the at least one arm bears against the glide board (2) near a longitudinal side of the glide board (2).

29. Glide board according to claim 27 or 28, characterized in that the plate consists of at least two plate elements (1′, 1″), each forming an arm or wing (6).

30. Glide board according to claim 27, characterized in that the plate consists of at least three plate elements (1b′, 1b″, 1b′″), of which two plate elements (1b′, 1b″) form the arms or wings (6) and of which a further plate element (1b′″) forms the top of the elevating plate.

31. Glide board according to one of the foregoing claims, characterized in that the plate elements are held together in an interlocking manner 32.

32. Glide board according to one of the foregoing claims, characterized in that the plate elements (1′, 1″; 1a′, 1a″; 1b′, 1b″, 1b′″) are connected together in a pivoted manner by means of at least one joint (10) on an axis perpendicular to the top (7) or bottom (8) of the plate.

33. Glide board according to one of the foregoing claims, characterized in that the respective arm or wing (6) extends radially or approximately radially from the plate in relation to the axis of the joint (10).

34. Glide board according to one of the foregoing claims, characterized in that the pivot axis is formed by a joint (10) on a side (3) of the plate (1) opposite from the arms or wings (6).

35. Glide board according to one of the foregoing claims, characterized in that the joint axis is located in the area of the opening (9a) of the plate (1a).

36. Glide board according to one of the foregoing claims, characterized in that the arms or wings (6) stand away from a middle part of the plate (1, 1a, 1b) forming the opening (9, 9a).

37. Glide board according to one of the foregoing claims, characterized in that the top (7) of the plate forms a surface for the binding or the binding element (14) in an area surrounding the opening (9, 9a).

38. Glide board according to claim 37, characterized in that the surface for the binding element (14) is formed in such a way that the binding element is secured against twisting in relation to the plate (1, 1a, 1b).

39. Glide board according to one of the foregoing claims, characterized in that the surface for the binding element (14) at least on the surface side adjacent to the binding element (14) is made of an elastomeric material.

40. Glide board according to one of the foregoing claims, characterized in that the plate has an elastic form at least in the area of the arms or wings (6) at least on the bottom (8) of the plate.

41. Glide board according to one of the foregoing claims, characterized in that inserts (20, 20′) or at least an intermediate layer (23) made of an elastomeric and/or damping material is provided for on the bottom (8) of the plate.

42. Glide board according to one of the foregoing claims, characterized in that the fastening means (15, 16) are designed in such a way that an angle adjustment of the binding element (14) in relation to the plate (1) is possible.

43. Glide board according to one of the foregoing claims, characterized in that the plate is essentially symmetrical in relation to the middle plane (M).

44. Glide board according to one of the foregoing claims, characterized in that the fastening means (16) extending through the at least one opening (9, 9a) and interlocking with the glide board (2) and/or anchoring elements (17) located there also serves to fasten the plate (1) to the glide board (2).

45. Glide board according to one of the foregoing claims, characterized in that the arms or wings (6) are tapered toward their free ends.

46. Glide board according to one of the foregoing claims, characterized in that the plate height at least in the area of the arms or wings (6) becomes smaller toward its free end.

47. Glide board according to one of the foregoing claims, characterized in that the plate is tapered on the side (3) adjacent to the arms or wings (6).

48. Glide board according to one of the foregoing claims, characterized by liners (23) and/or inserts (24) for adjusting the height.

49. Glide board according to one of the foregoing claims, characterized by its being manufactured from metal and/or plastic.

50. Glide board according to one of the foregoing claims, characterized in that the fastening means for fastening the plate to the glide board consist of bolts (28) that can be anchored with one end in the glide board or in anchoring elements (17) located there and have means, for example a thread or a threaded hole (28′″) for fastening a binding or a binding element.

51. Glide board according to claim 50, characterized in that the bolts (28) form a bearing surface (28″) for bearing against the plate or a plate element (1b″).

52. Glide board according to claim 50 or 51, characterized in that the bolts (28) form a bearing surface (28″) for the binding.

53. Glide board according to one of the foregoing claims, characterized in that the bolts are provided with a collar (28″) for bearing against the plate or against a plate element (1b′″).
